(19) United States
(12) Patent Application Publication
(10) Pub. No.: US 2010/0239369 A1
(43) Pub. Date: Sep. 23, 2010

(54) STATIC ADVERTISING SYSTEM FOR ALL TYPES OF GRASS SURFACES

(76) Inventor: Juan Miguel Mayordomo Vicente, Esplugas de Llobregat (ES)

Correspondence Address: STURM & FIX LLP, 206 SIXTH AVENUE, SUITE 1213, DES MOINES, IA, 50309-4076, US

(21) Appl. No.: 12/600,408

(22) PCT Filed: May 14, 2008
(86) PCT No.: PCT/ES08/00343

§ 371 Date: May 6, 2010

(30) Foreign Application Priority Data
May 17, 2007 (ES) P200701347

(51) Int. Cl. G09F 19/00

(52) U.S. Cl. 404/93

(57) ABSTRACT

Static advertising system for all types of grass surfaces, such as natural and artificial grass, with a continuous or tiled surface, and others, which consists of preferably placing a series of templates on the grass and then proceeding to cut it with different cutting angles and/or different mowing directions, said templates having their configuration suited to the type of cut to be made, in order to obtain representations with characters and graphics, such as brand names, designs, logos, etc., for advertising or informative purposes.

### PURPOSE OF THE INVENTION

This Patent application relates to a static advertising system for all types of grass surface, offering a series of advantages to the function for which it is intended, which are described hereunder, as well as other advantages inherent to its organisation and make-up.

More specifically, the invention consists of a static advertising system for natural or artificial grass surfaces, with a continuous or tiled surface, in short, for any type of grass surface.

### BACKGROUND OF THE INVENTION

At present, in reference to the state of the art, it should be noted that there are known means for representing characters and graphics for advertising purposes on grass surfaces by painting.

The main drawback of this is that, when the grass grows and needs to be periodically mowed, it needs to be painted again.

### DETAILED DESCRIPTION OF THE INVENTION

To avoid these drawbacks, a static advertising system for all types of grass surfaces has been devised, which is the subject of this invention, consisting of preferably placing a series of templates on the grass and then proceeding to cut it with different cutting angles and/or different mowing directions, said templates having their configuration suited to the type of cut to be made, in order to obtain representations with characters and graphics, such as brand names, designs, logos, etc., for advertising or informative purposes.

The invention is applicable in sports facilities, companies, institutional headquarters and other sites that contain any type of grass surfaces.

Likewise, the invention is also applicable for various virtual reality games, such as sporting events and others.

1. (canceled)

2. Static advertising system for all types of grass surfaces, such as natural and artificial grass, with a continuous or tiled surface, using a mechanism equipped with a helical drum comprising cutting blades, comprised in that a series of guiding patterns are placed on the grass with a configuration suited to the type and shape of the cut to be made, in order to obtain representations with characters and graphics, such as brand names, designs, logos, etc., for advertising or informative purposes.

3. Static advertising system for all types of grass surfaces according to claim 2, comprised in that the inclination of the cutting blades varies according to the characteristics of the figures and symbols that make up the areas to be cut.

4. Static advertising system for all types of grass surfaces according to claim 3, comprised in that a rotating direction of the helical drum mechanism comprising the cutting blades varies according to the various mowing directions and the characteristics of the figures and symbols that make up the areas to be cut.

5. Static advertising system for all types of grass surfaces according to claim 4, comprised in that the rotating direction of the helical drum mechanism comprising the cutting blades varies according to the various mowing directions and the characteristics of the figures and symbols that make up the areas to be cut.
